(19) United States
(12) Patent Application Publication
(10) Pub. No.: US 2010/0319558 A1
(43) Pub. Date: Dec. 23, 2010

(54) CHAMBER DOCTOR BLADE ON A PRINTING MACHINE

(76) Inventors: Frank Hasselmann, Osnabrueck (DE); Frank Gunschera, Osnabrueck (DE)

Correspondence Address: JACOBSON HOLMAN PLLC, 400 SEVENTH STREET N.W., SUITE 600, WASHINGTON, DC, 20004, US

(21) Appl. No.: 12/735,989

(22) PCT Filed: Feb. 23, 2009
(86) PCT No.: PCT/EP2009/052119

§ 371 Date: Aug. 31, 2010

(30) Foreign Application Priority Data
Mar. 4, 2008 (DE) 10 2008 012 552.0

(51) Int. Cl. B41F 9/10

(52) U.S. Cl. 101/157

(57) ABSTRACT

The invention describes a chamber doctor blade (1) for a rotary press to be applied to an ink transfer roller (2) of a rotary press. This chamber doctor blade (1) comprises a doctor blade base (3) which, when applied to the ink transfer roller (2), extends in the axial direction thereof and which comprises at least one groove-type recess (7) extending in the direction of extension, at least two doctor blades (9) which are disposed in a roof-like manner and at least the edges of which can be applied to the ink transfer roller, front walls (15) which laterally separate the at least one groove-type recess from the surroundings and at least one separating device (16) in the groove-type recess, which separating device divides the groove-type recess into a main chamber (18) and one or more secondary chambers (17). The at least one separating device (16) has at least one opening (19).

The invention relates to a chamber doctor blade according to the generic clause of claim 1.

Printing ink is provided by means of such chamber doctor blades to ink transfer rollers such as screen rollers in flexo printing or form cylinders in gravure printing. The ink transfer rollers comprise small grooves filled with printing ink. The printing ink is delivered to additional ink transfer rollers or the substrate. The now empty grooves usually referred to as “cells” in the case of screen rollers can be filled with fresh printing ink during the next circulation inside the chamber doctor blade.

For this purpose, the chamber doctor blade and the ink transfer roller together form a self-contained system. The chamber doctor blade comprises a doctor blade base which, when applied to the ink transfer roller, extends along the axial direction of the ink transfer roller. At least two doctor blades are attached to the doctor blade base in a manner not described here in detail. The doctor blades that can be classified as working blade and closing blade are in contact with the surface of the ink transfer roller and they seal the internal space of the chamber doctor blade in relation to the surroundings, when viewed in the circumferential direction of the ink transfer roller. In order to also seal the front side of the internal space of the chamber doctor blade in relation to the surroundings, walls are provided here. In order to increase the leak tightness of these front walls, seals are usually disposed on the walls such that the seals are oriented away from the internal space of the groove-type recess and their narrow sides are likewise in contact with the ink transfer roller.

A chamber doctor blade of such kind is disclosed in the patent EP 0 822 897 B1. The special feature of the chamber doctor blade disclosed in the aforementioned document is the so-called throttle gaps that serve the purpose explained below. In order to be able to refill the grooves with printing ink, the printing ink must be supplied to the chamber doctor blade at a defined excess pressure. On the other hand, the empty grooves bring air into the doctor blade chamber and this air must be discharged. Therefore, a chamber doctor blade must also comprise one or more ink-discharge openings and/or vent holes in addition to an ink-supply opening. In order to now maintain the excess pressure in the ink chamber in spite of the ink-discharge openings and/or the vent holes, separating devices formed as partition walls are provided that divide the groove-type recess of the chamber doctor blade into a main chamber and one or more secondary chambers. The partition walls form a throttle gap with the ink transfer rollers so that reduced pressure prevails in the secondary chambers as compared to the main chamber. It is advantageous if the ink-discharge openings and/or the vent holes in the doctor blade base are disposed in the region of these secondary chambers. The ink-supply opening is advantageously guided into the main chamber. The embodiment described is disclosed in said patent specification.

These chamber doctor blades have proven themselves very well in the past. In recent times, however, efforts have been made to distinctly increase the operating speed of printing machines. This also results in the requirement of transporting a greater ink volume in the same period of time by means of the chamber doctor blades and the ink transfer rollers in the direction of the substrate. However, this means that an increased volume of air per time unit is brought into the doctor blade chamber. The increasing printing speed also increasingly causes problems with regard to the discharge of this excess air. This problem is further aggravated by the fact that the air is heavily mixed with fresh printing ink as a result of the likewise increasing circumferential speed of the ink transfer roller. The printing ink gets positively foamed up. All of this results in increasingly impairing the possibility of completely filling the grooves of the ink transfer rollers with fresh printing ink. This fact even restricts the possibility of further increasing the printing speed.

It is therefore the object of the present invention to suggest an improved chamber doctor blade, by means of which the grooves of ink transfer rollers can be completely filled with fresh printing ink even at increased printing speeds.

This object is achieved by means of the features of the characterizing part of claim 1.

It is thus suggested that at least one separating device have at least one opening. In this way, it is possible for the air, with which the fresh printing ink is loaded, to escape through the partition wall without having to pass a throttle gap. It is now possible to discharge a greater volume of air per time unit. The air thus arrives into a secondary chamber where it can escape through a vent hole, if the latter is present. The air can naturally also be discharged in any other suitable way.

This invention is based on the finding that a vortex is formed inside the chamber doctor blade at least at higher circumferential speeds of the ink transfer rollers. This vortex receives at least a part of its kinetic energy from the ink transfer roller. The vortex acts as a cyclone (centrifugal separator), a centrifugal force acting on the heavier elements and driving the same outwardly. Accordingly, the air concentrates in the interior of the vortex, thus at the vortex center, and forms an air column here. This results in a separation of air from the printing ink. According to experiments, the rotation axis of such a vortex is parallel to the axis of the ink transfer roller.

It has turned out to be surprising that the opening provided in the partition wall, as suggested by the invention, which partition wall is often also referred to as a barrier and practically delimits such a vortex on the front side, enables the air that is mostly under excess pressure to escape. In contrast, printing ink usually arrives only in small amounts or does not arrive at all into the opening. Due to the invention, it is thus possible to discharge a relatively large amount of air from the doctor blade chamber without losing the necessary excess pressure of the printing ink in the main chamber. On the whole, the air brought into the doctor blade chamber by means of the grooves in an ink transfer roller can be discharged very reliably and effectively. As a result, the grooves of the ink transfer roller can now be filled reliably and completely with printing ink. The effect observed in conventional chamber doctor blades, according to which the print quality deteriorates at increasing printing speeds does not occur so that a chamber doctor blade no longer is the speed-limiting link in the chain of ink transport. With this invention, the proper loading of the ink transfer roller with fresh ink can be labeled as speed-independent.

It is particularly advantageous if the at least one opening is circular. The vortex formed inside the chamber doctor blade likewise usually has a circular shape. Particularly the central air inclusion takes this shape so that a circular opening provides the air with an appropriately dimensioned outlet for escape.

In an advantageous development of the invention, a pipe or tube section can be guided through the opening, as a result of which it is possible to discharge the air from those regions of the chamber doctor blade that are located further toward the center. In this context, it is advantageous if the pipe or tube section extends into the at least one secondary chamber and is curved or bent at an angle there. The air discharged from the vortex can be guided in a desired direction, for example, in the direction of the vent hole. Alternatively, the pipe or tube section can also connect the opening with the surroundings of the chamber doctor blade and can thus be guided through the vent hole. It is then possible to dispense with additional vent holes that are guided outwardly from the secondary chambers.

In a further advantageous embodiment of the invention, a profiled body is provided in the interior of the chamber doctor blade. This profiled body can be formed integrally with the doctor blade base. Alternatively, this profiled body can be inserted into the groove-type recess. This is recommended particularly when a cost-effective production of chamber doctor blades having variably shaped profiled bodies is intended. The profiled body has a special shape that will be described and explained in more detail below.

When viewed in the circumferential direction of the ink transfer roller, the profiled body comprises an elevation. In the region of this elevation, the distance between the profiled body and the circumferential surface of the ink transfer roller is small so that a bottleneck is formed. However, the profiled body does not rest against the ink transfer roller. It is possible by means of the bottleneck to specifically control the flow direction and also the flow speed of the printing ink or the printing ink/air mixture. Experiments have shown that the air vortex described above is formed in most cases behind this bottleneck. Air and printing ink can be separated reliably as a result. This leads to the grooves of the ink transfer roller disposed behind the bottleneck to be refilled with fresh printing ink. The reason being that, due to formation of the vortex described above, only a small amount of air or, in the ideal case, no air is now present in the printing ink coming into contact with the ink transfer roller.

It is advantageous if the elevation is formed as an edge. From a mathematical point of view, this means that the line proceeds discontinuously across the elevation, when viewed in the cross section of the profiled body. As a result of the expansion behind the edge, the printing ink already present in this region of the chamber is entrained by the printing ink adhering to the ink transfer roller so that the aforementioned vortex is formed so as to be stationary.

In a further embodiment, the elevation is located behind the center plane of the chamber doctor blade, when viewed in the rotational direction of the ink transfer roller. The center plane divides the distance between the two outer sides of the chamber doctor blade into two halves and is additionally orthogonal to the rear side of the chamber doctor blade. As a result of this arrangement of the elevation, the vortex center is essentially pushed into a region located below the working blade. Thus, the doctor blade here is located between the vortex and the ink transfer roller. This can reduce the probability of air re-entering into the grooves of the ink transfer roller.

In order to be able to further improve the control of the ink flow, the profiled body advantageously has a specially shaped cross section. When viewed in the rotational direction of the ink transfer roller, the distance between the circumferential surface of the ink transfer roller and the surface of the profiled body initially decreases continuously before the elevation. The term “continuously” is meant to be understood in the mathematical sense, which means that there are no bends or edges in the profile. The term “distance” can also denote the distance between the profile and a tangent plane resting against the ink transfer roller and extending orthogonally to the center plane of the doctor blade chamber. In this case also, the distance decreases continuously according to the invention. Behind the elevation, the distance between the profile and the circumferential surface of the ink transfer roller or the tangent plane resting against the same increases continuously. It must be emphasized at this point that the elevation—as described above, can by all means represent a discontinuity in the cross-sectional profile of the profiled body.

It is particularly advantageous if the aforementioned openings of the partition walls are also located behind the elevation, when viewed in the rotational direction of the ink transfer roller. If the vortex center is formed at this location, it is also necessary to provide the openings in this region.

An exemplary embodiment of the invention is explained below in the present description and the drawings.

In the individual figures:

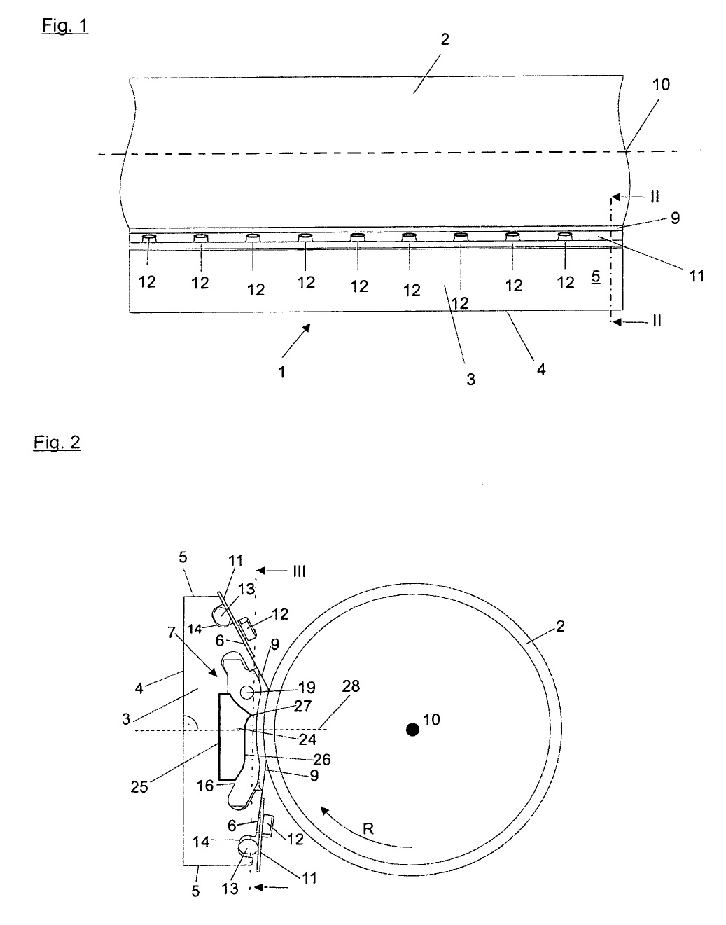

FIG. 1 is a view of a chamber doctor blade and an ink transfer roller known from the prior art

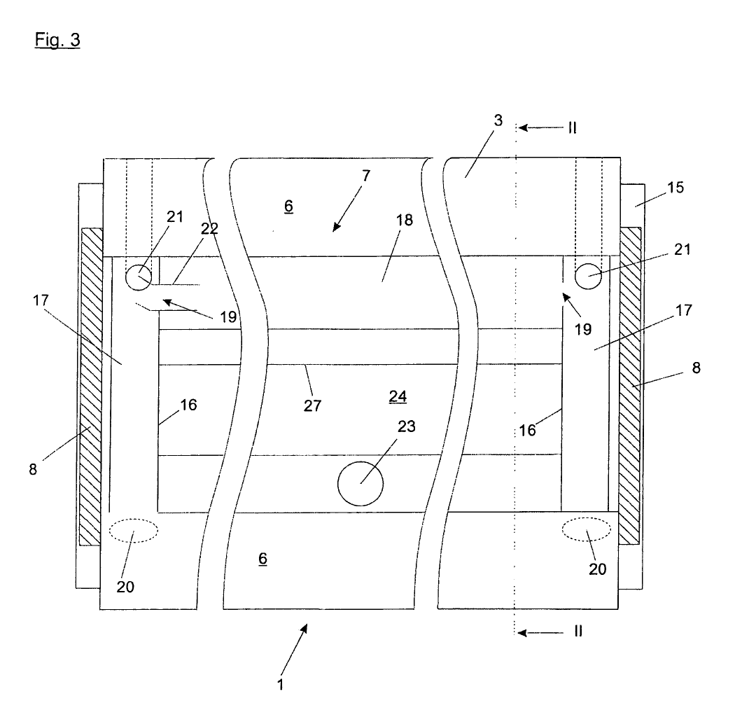

FIG. 2 is a view of section II-II marked in FIG. 1 and FIG. 3

FIG. 3 is a view of section III-III marked in FIG. 2

FIGS. 1 and 2 are two views of a chamber doctor blade 1 and an ink transfer roller 2. In the example shown, the ink transfer roller 2 is formed as a screen roller in a manner not shown in detail. The chamber doctor blade 1 comprises a doctor blade base 3 that can naturally comprise several parts. As is evident from FIG. 2, the doctor blade base 3 comprises a flat bottom side 4 and two lateral surfaces 5 connected to the flat bottom side 4 at an angle. Those sides of the doctor blade base 3 that are oriented toward the ink transfer roller 2 comprise two inclined surfaces 6 delimiting a groove-type recess 7 between them. Parts of the inclined surfaces 6 are the supporting surfaces for the doctor blades 9. The doctor blades 9 are applied to the ink transfer roller 2 such that the internal space delimited by the recess 7, the ink transfer roller 2, the doctor blades 9 and the front seals 8, which are shown in FIG. 3 and which likewise rest against the ink transfer roller 2, can be filled with ink such that the ink does not leak outside.

As is apparent from FIG. 1, the doctor blade base 3 extends parallel to the rotation axis 10 of the ink transfer roller 2. This parallel direction is also referred to as “axial direction.”

For fixing the doctor blades 9 on the supporting surfaces, clamping strips 11 are provided, which are subjected to forces the resultant of which is oriented in the direction of the doctor blade base 3. One of these forces, to which the clamping strip 11 is subjected, originates in the screws 12 that pass through holes, preferably slotted holes, in the clamping strip 11 and are screwed to the doctor blade base 3. The bottom sides of the screw heads reach beyond the edge of the holes so that, when the clamping strip 11 is subjected to a force oriented away from the doctor blade base 3 by means of the continuous shaft 13, the doctor blade cannot be removed from the doctor blade base 3. Since the points of action of the shaft 13 and the screws are at a distance from each other, the clamping strip acts as a lever, the force of which can be used for fixing the doctor blades. The upper clamping strip 11 in FIG. 2 is shown in the detached position. In this case, the doctor blade can be removed, for example, by pulling it out in the axial direction. The lower clamping strip 11 is shown in the fixed position, in which the clamping strip presses the doctor blade 9 onto the inclined surface 6.

In order to ensure that the doctor blade is detachable, the shaft visible in FIG. 2 is shaped eccentrically so that the distance of the clamping strip 11 from the doctor blade base 3 and thus the fixing force can be altered by means of a rotation of the shaft 13. In order to prevent the shafts 13 from evading the clamping strip 11, the shafts 13 are inserted in shell-like channels 14 when the clamping strips 11 are fixed.

FIG. 3 is a top view of a chamber doctor blade 1 of the invention. Also visible here are the lateral walls 15, to the inner sides of which seals 8 are applied that in turn seal the groove-type recess from the exterior so that printing ink cannot leak sideways.

The groove-type recess is divided into a plurality of sub-chambers by means of partition walls 16. In the exemplary embodiment illustrated, partition walls 16 each separate a secondary chamber 17 from the main chamber 18. The secondary chambers 17 are disposed in the end regions of the chamber doctor blade 1. The advantage of this separation has already been explained in detail in this document and can also be inferred from EP 0 822 897 B1 cited at the start. It is also possible to provide a plurality of partition walls 16 so as to result in a plurality of secondary chambers. Each partition wall 16 then ensures a drop in pressure.

The doctor blade base 3 has various discharge openings in the region of the secondary chambers 17. These disposal openings include firstly the discharge openings 20 that serve for discharging excess printing ink from the chamber doctor blade 1. This discharged printing ink is conveyed in the ink fountain so that this ink is again made available to the printing process. Furthermore, vent holes 21 are provided. Air that has entered into the chamber doctor blade 1 from the empty cells of the ink transfer roller 2 can be discharged outward by means of the vent holes 21.

The main chamber 18 is provided with a supply opening 23 used for the supply of printing ink. It is also possible to provide a plurality of supply openings.

The partition walls 16 separating the secondary chambers 17 from the main chamber 18 each comprise an opening 19, by means of which air present inside a vortex forming during the printing operation can escape. These openings 19 can be circular, as is evident from FIG. 2. Small tubes 22, by means of which the direction of airflow can be controlled, can additionally be mounted in the openings 19. Such a tube is shown for the left partition wall 16 in FIG. 3. This tube 22 can be bent in its end region, as illustrated, so that the air is directed toward the vent hole 21. The right partition 16 is shown without an additional tube in the exemplary embodiment.

In the groove-type recess 7, the doctor blade base 3 comprises one more recess 25, into which a profiled body 24 can be inserted. This profiled body 24 can be mounted appropriately, for example, by means of a screw connection, in the doctor blade base 3 and detached again. In this way, a chamber doctor blade 1 of the invention can be modified to meet various requirements, for example, various printing speeds. At low printing speeds required, for example, in the case of special substrates, the entry of air is rather small so that usually no problems occur when filling the grooves of the ink transfer roller 2. In this case, the flow of the ink in the chamber doctor blade 1 need not be controlled so that it is possible to dispense with a profiled body.

That surface 26 of the profiled body 24 that is oriented toward the ink transfer roller 2 has a special contour, when viewed in its cross section. Firstly, this contour comprises an essentially rising profile, which culminates in an edge 27, when viewed in the rotational direction R of the ink transfer roller 2. A heavily sloping profile is then provided. By means of the profile described, the air/ink mixture entrained by the ink transfer roller is compressed so that its pressure rises. This pressure rise continues up to the edge 27. The strongly pressurized mixture is entrained by the ink transfer roller 2 and peeled off only by the doctor blade 9 from the surface of the ink transfer roller 9. As a result of the expanded region behind the edge 27, the air/ink mixture forms a stationary vortex since the mixture is reverted starting from the doctor blade 9 and steered again behind the edge 27 in the direction of the ink transfer roller 2 and is thus rotated. Since air and printing ink are separate from each other up to this point due to the cyclone effect of the vortex, fresh printing ink reaches the ink transfer roller without any intermixing of air. The resulting vortex is characterized in that an air column is formed at its center. By means of a suitable combination of the profile and the arrangement of openings 19, it is possible to align the openings 19 with the air column so that exclusively air and not printing ink leaves the openings 19.

In this connection, it can be advantageous to arrange the edge 27 in such a way that it is located behind a plane 28, which is orthogonal to the bottom side 4 of the chamber doctor blade and which divides the chamber doctor blade into an upper and a lower half, when viewed in the direction R. As a result of this arrangement, said vortex can be formed in a region located below the doctor blade 9. This measure ensures that no air enters the grooves of the ink transfer roller 2 as far as possible.

List of reference numerals

| | |
|---|---|
| 1 | Chamber doctor blade |
| 2 | Ink transfer roller |
| 3 | Doctor blade base |
| 4 | Bottom side |
| 5 | Lateral surface |
| 6 | Inclined surface |
| 7 | Groove-type recess |
| 8 | Front seals |
| 9 | Doctor blade |
| 10 | Rotation axis of the ink transfer roller |
| 11 | Clamping strips |
| 12 | Screw |
| 13 | Shaft |
| 14 | Shell-like channel |
| 15 | Lateral wall |
| 16 | Partition wall |
| 17 | Secondary chamber |
| 18 | Main chamber |
| 19 | Opening |
| 20 | Discharge openings |
| 21 | Vent hole |
| 22 | Tube |
| 23 | Supply opening |
| 24 | Profiled body |
| 25 | Recess |
| 26 | That surface of the profiled body that is |
| | oriented toward the ink transfer roller |
| 27 | Edge |
| 28 | Plane |
| R | Rotational direction of the ink transfer roller |

1. A chamber doctor blade (1) for a rotary press to be applied to an ink transfer roller (2) of a rotary press, the chamber doctor blade (1) having at least the following features:
a doctor blade base (3) which, when applied to the ink transfer roller (2), extends in the axial direction thereof and which comprises at least one groove-type recess (7) extending in the direction of extension,
at least two doctor blades (9) which are disposed in a roof-like manner and at least the edges of which can be applied to the ink transfer roller,
front walls (15) which laterally separate the at least one groove-type recess from the surroundings,
at least one separating device (16) in the groove-type recess, which separating device divides the groove-type recess into a main chamber (18) and one or more secondary chambers (17),
said chamber doctor blade being characterized in that the at least one separating device (16) has at least one opening (19).

2. The chamber doctor blade (1) according to claim 1, characterized in that
the at least one opening (19) is circular.

3. The chamber doctor blade (1) according to claim 1,
characterized in that
a pipe or tube section (22) can be guided through the opening (19).

4. The chamber doctor blade (1) according to the preceding claim,
characterized in that
the pipe or tube section (22) extends into the at least one secondary chamber (17) and is curved or bent at an angle here.

5. The chamber doctor blade (1) according to claim 1,
characterized in that
the main chamber (18) comprises a profiled body (24) that extends in the direction of the groove-type recess (7) and that comprises an elevation (27) forming a bottleneck with the ink transfer roller (2), when viewed in the circumferential direction (R) of the ink transfer roller (2).

6. The chamber doctor blade (1) according to the preceding claim,
characterized in that
the elevation is formed as an edge (27).

7. The chamber doctor blade (1) according to claim 5,
characterized in that
the elevation (27) is located behind the center plane (28) of the chamber doctor blade (1), when viewed in the rotational direction (R) of the ink transfer roller (2).

8. The chamber doctor blade (1) according to claim 5,
characterized in that
the profiled body (24) comprises a profile, in which the distance of the profiled body from the ink transfer roller decreases continuously before the elevation (27) and again increases continuously behind the elevation (27), when viewed in the rotational direction (R) of the ink transfer roller (2).

9. The chamber doctor blade (1) according to claim 5,
characterized in that
the openings (19) of the separating devices (16) are located behind the elevation (27) of the profiled body (24), when viewed in the rotational direction (R) of the ink transfer roller (2).
